(19) United States
(12) Patent Application Publication
(10) Pub. No.: US 2023/0364696 A1
(43) Pub. Date: Nov. 16, 2023

(54) Carpet Glue Removal Assembly

(71) Applicant: Guillermo Guerrero, Whittier, CA (US)

(72) Inventor: Guillermo Guerrero, Whittier, CA (US)

(21) Appl. No.: 17/743,221

(22) Filed: May 12, 2022

(51) Int. Cl. B23D 79/08; B23D 79/06

(52) U.S. Cl. CPC B23D 79/08; B23D 79/06

(57) ABSTRACT

A carpet glue removal assembly includes a plate that has a curved tail piece. A coupler is coupled to the plate and the coupler is attachable to an oscillating tool thereby facilitating the plate to be oscillated when the oscillating tool is turned on. The coupler is positioned adjacent to the curved tail piece such that the plate is directed forwardly from the oscillating tool. A blade is removably coupled to the plate and the blade extends forwardly from the plate. In this way the blade can engage adhesive on a floor such that blade removes the adhesive from the floor when the plate is oscillated. A pair of fasteners is each extendable through a respective hole in the panel and a respective aperture in the blade thereby attaching the blade to the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to glue removal device and more particularly pertains to a new glue removal device for removing carpet adhesive from a hard floor surface. The device includes a plate with a curved tail piece and a coupler that is attached to the plate. The coupler is designed to fit a chuck of an oscillating tool. Additionally, a blade is removably attachable to the plate and the blade has a saw-tooth edge for abrading carpet adhesive from the hard floor surface when the oscillating tool is turned on.

### (2) Description of Related Art Including Information Disclosed Under 37 CFR 1.97 and 1.98

The prior art relates to glue removal devices including a curved mounting plate that has an opening for insertably receiving an output shaft of an oscillating tool and cutting blade that is slidably attached to the curved mounting plate. The prior art discloses a power tool accessory that including a curved mounting plate that has an angled front edge and a blade that is attachable to the angled from edge of curved mounting plate. The prior art discloses a cutting blade device that includes a curved mount that has a hooked cutting edge and curved cutting edge. The prior art discloses a cutting device that includes a mounting plate for attaching to an oscillating tool, a guide section integrated into the mounting plate for guiding the mounting plate along a work-piece. The prior art discloses a cutting tool device that which has a curved cutting edge comprising a saw-tooth pattern. The prior art discloses a cutting tool device for an oscillating tool that has a straight cutting edge, a curved cutting edge and a hooked cutting edge. The prior art discloses an ornamental design for a cutting blade for an oscillating tool that includes a stepped mounting plate, a cutting blade that is removably attachable to the stepped mounting plate and a star shaped opening in the stepped mounting plate for engaging an output shaft of the oscillating tool.

### BRIEF SUMMARY OF THE INVENTION

An embodiment of the disclosure meets the needs presented above by generally comprising a plate that has a curved tail piece. A coupler is coupled to the plate and the coupler is attachable to an oscillating tool thereby facilitating the plate to be oscillated when the oscillating tool is turned on. The coupler is positioned adjacent to the curved tail piece such that the plate is directed forwardly from the oscillating tool. A blade is removably coupled to the plate and the blade extends forwardly from the plate. In this way the blade can engage adhesive on a floor such that blade removes the adhesive from the floor when the plate is oscillated. A pair of fasteners is each extendable through a respective hole in the panel and a respective aperture in the blade thereby attaching the blade to the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1A is a top phantom view of a carpet glue removal assembly according to an embodiment of the disclosure.

FIG. 1B is a bottom phantom view of an embodiment of the disclosure.

FIG. 2 is an exploded perspective view of an embodiment of the disclosure.

FIG. 3 is a right side view of an embodiment of the disclosure.

FIG. 4 is a front perspective view of an embodiment of the disclosure.

FIG. 5 is a perspective in-use view of an embodiment of the disclosure.

### DETAILED DESCRIPTION OF THE INVENTION

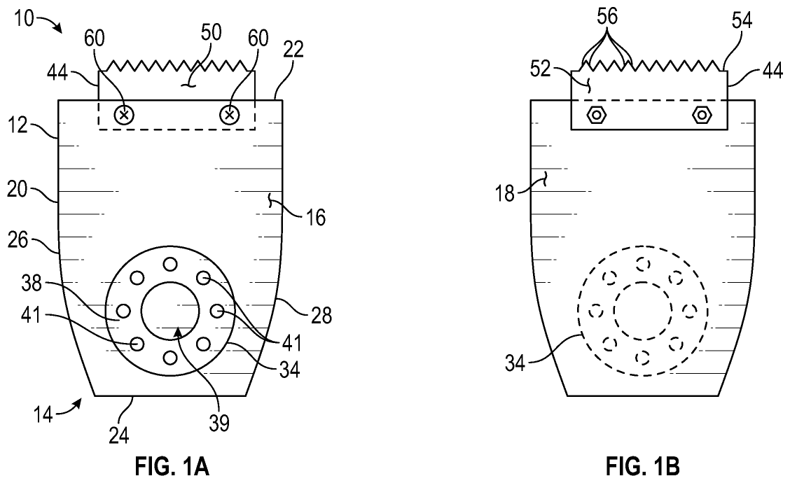

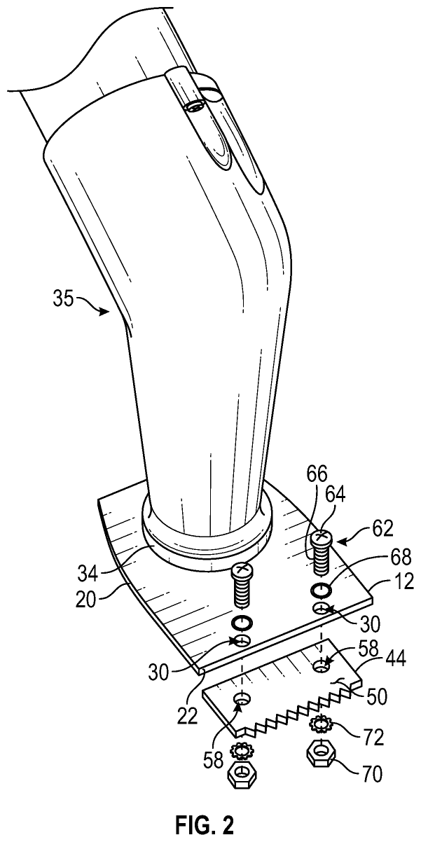

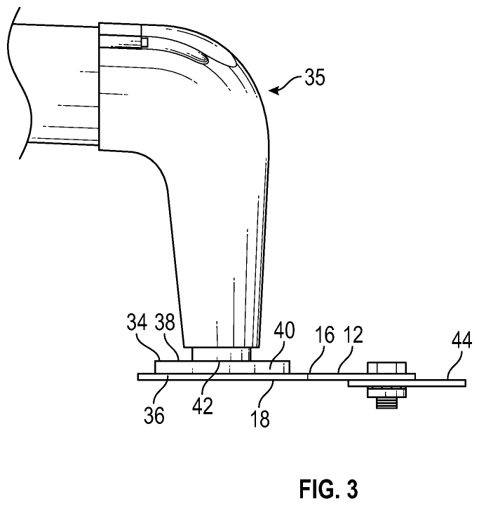

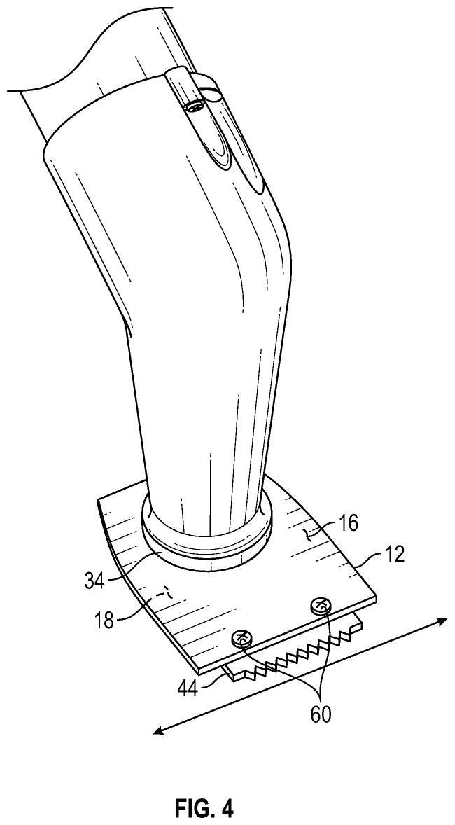

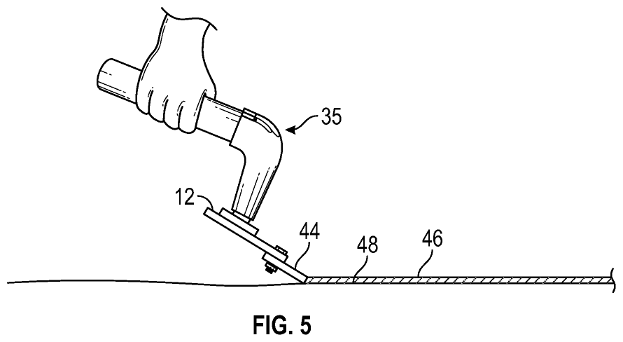

With reference now to the drawings, and in particular to FIGS. 1 through 5 thereof, a new glue removal device embodying the principles and concepts of an embodiment of the disclosure and generally designated by the reference numeral 10 will be described.

As best illustrated in FIGS. 1 through 5, the carpet glue removal assembly 10 generally comprises a plate 12 that has a curved tail piece 14. The plate 12 has a top surface 16, a bottom surface 18 and a perimeter edge 20 extending between the top surface 16 and the bottom surface 18, and the perimeter edge 20 has a front side 22, a back side 24, a first lateral side 26 and a second lateral side 28. The plate 12 has a pair of holes 30 each extending through the top surface 16 and the bottom surface 18, each of the holes 30 is positioned adjacent to the front side 22 of the perimeter edge 20, and the holes are spaced apart from each other and are distributed along the front side 22. The front side 22 has a width that is greater than a width of the back side 24. Furthermore, each of the first lateral side 26 and the second lateral side 28 curves inwardly at a point located adjacent to the back side 24 of the perimeter edge 20 such that the back side 24 has a width that is less than the width of the front side 22 of the perimeter edge 20.

A coupler 34 is coupled to the plate 12 and the coupler 34 is attachable to an oscillating tool 35 thereby facilitating the plate 12 to be oscillated when the oscillating tool 35 is turned on. The coupler 34 is positioned adjacent to the curved tail piece 14 such that the plate 12 is directed forwardly from the oscillating tool 35. Additionally, the coupler 34 has a bottom end 36, a top end 38 and an outer surface 40 extending between the top end 38 and the bottom end 36, and the bottom end 36 is coupled to the top surface 16 of the plate 12. As is most clearly shown in FIGS. 1A and 1B, the coupler 34 may have a primary hole 39 extending through the top end 38 and the bottom end 36, and the top end 36 may have a plurality of secondary holes 41 that are distributed around the primary hole 39.

The coupler 34 is centrally positioned between the first lateral side 26 and the second lateral side 28 of the perimeter edge 20 of the panel. Moreover, the coupler 34 is positioned adjacent to the curve 32 in each of the first lateral side 26 and the second lateral side 28 of the perimeter edge 20 of the plate 12 forwardly from an output shaft 42 of the oscillating tool 35 when the coupler 34 is attached to the output shaft 42. The coupler 34 may be structured to accommodate a chuck on the oscillating tool 35 regardless of the manufacturer of the oscillating tool 35.

A blade 44 is removably coupled to the plate 12 and the blade 44 extends forwardly from the plate 12 thereby facilitating the blade 44 to engage adhesive 46 on a floor 48 such that blade 44 removes the adhesive 46 from the floor 48 when the plate 12 is oscillated. The adhesive 46 may be carpet adhesive, or other type of flooring adhesive, and the floor 48 may be a concrete floor or other type of hard floor. The blade 44 has an upper surface 50, a lower surface 52 and a front edge 54 extending between the upper surface 50 and the lower surface 52. The front edge 54 has a series of intersecting faces 56 that are arranged to define a saw tooth pattern on the front edge 54 thereby facilitating the front edge 54 to abrade the adhesive 46 when the plate 12 is oscillated.

The blade 44 has a pair of apertures 58 each extending through the upper surface 50 and the lower surface 52. The apertures 58 are spaced apart from each other and are distributed along a line that is oriented parallel with the front edge 54. Additionally, the upper surface 50 is abutted against the bottom surface 18 of the plate 12 having each of the apertures 58 being aligned with a respective one of the holes 30 in the plate 12. A pair of fasteners 60 is provided and each of the fasteners 60 is extendable through a respective hole 30 in the panel and a respective aperture 58 in the blade 44 thereby attaching the blade 44 to the panel.

Each of the fasteners 60 comprises a screw 62 that has a head 64 and a shaft 66. The shaft 66 of each screw 62 is extended through a respective hole 30 and a respective aperture 58 has the head 64 abutting the top surface 16 of the plate 12. Each of the fasteners 60 includes a washer 68 that is positioned around the screw 62 such that the washer 68 is positioned between the head 64 and the top surface 16 of the plate 12. Each of the fasteners 60 includes a nut 70 that is threadable onto the shaft 66 of the screw 62 and the nut 70 compresses against the lower surface 52 of the blade 44 when the nut 70 is tightened on the screw 62. Each of the fasteners 60 includes a lock washer 72 that is positioned around the screw 62 such that the lock washer 72 is positioned between the nut 70 and the lower surface 52 of the blade 44 for inhibiting the nut 70 from loosening when the nut 70 is tightened.

In use, the coupler 34 is inserted into the output shaft 42 of the oscillating tool 35 and the blade 44 is positioned against the floor 48. In this way the blade 44 is rapidly vibrated when the oscillating tool 35 oscillates the plate 12 for efficiently abrading the adhesive 46 from the floor 48. In this way the adhesive 46 can be removed from the floor 48 without requiring excessive effort. Furthermore, the blade 44 can be removed and replaced when the blade 44 becomes dulled or is damaged.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A carpet glue removal assembly for removing flooring adhesive from a concrete floor, said assembly comprising:
a plate having a curved tail piece;
a coupler being coupled to said plate, said coupler being attachable to an oscillating tool thereby facilitating said plate to be oscillated when the oscillating tool is turned on, said coupler being positioned adjacent to said curved tail piece such that said plate is directed forwardly from the oscillating tool;
a blade being removably coupled to said plate, said blade extending forwardly from said plate thereby facilitating said blade to engage adhesive on a floor such that blade removes the adhesive from the floor when said plate is oscillated; and
a pair of fasteners, each of said fasteners being extendable through a respective hole in said panel and a respective aperture in said blade thereby attaching said blade to said panel.

2. The assembly according to claim 1, wherein:
said plate has a top surface, a bottom surface and a perimeter edge extending between said top surface and said bottom surface, said perimeter edge having a front side, a back side, a first lateral side and a second lateral side;
said plate has a pair of holes each extending through said top surface and said bottom surface, each of said holes being positioned adjacent to said front side of said perimeter edge, said holes being spaced apart from each other and being distributed along said front side;
said front side has a width being greater than a width of said back side; and
each of said first lateral side and said second lateral side curves inwardly at a point located adjacent to said back side such that said back side has a width being less that a width of said front side.

3. The assembly according to claim 2, wherein said coupler has a bottom end, a top end and an outer surface extending between said top end and said bottom end, said bottom end being coupled to said top surface of said plate, said coupler being centrally positioned between said first lateral side and said second lateral side of said perimeter edge of said panel, said coupler being positioned adjacent to said curve in each of said first lateral side and said second lateral side such that said plate is directed forwardly from an output shaft of the oscillating tool when said coupler is attached to the output shaft.

4. The assembly according to claim 2, wherein:
said blade has an upper surface, a lower surface and a front edge extending between said upper surface and said lower surface, said front edge having a series of intersecting faces being arranged to define a saw tooth pattern on said front edge thereby facilitating said front edge to abrade the adhesive when said plate is oscillated; and
said blade has a pair of apertures each extending through said upper surface and said lower surface, said apertures being spaced apart from each other and being distributed along a line being oriented parallel with said front edge, said upper surface being abutted against said bottom surface of said plate having each of said apertures being aligned with a respective one of said holes in said plate.

5. The assembly according to claim 4, wherein each of said fasteners comprises:
a screw having a head and a shaft, said shaft of each of said screws being extended through a respective hole and a respective aperture having said head abutting said top surface of said plate;
a washer being positioned around said screw such that said washer is positioned between said head and said top surface of said plate;
a nut being threadable onto said shaft of said screw, said nut compressing against said lower surface of said blade when said nut is tightened on said screw; and
a lock washer being positioned around said screw such that said lock washer is positioned between said nut and said lower surface of said blade for inhibiting said nut from loosening when said nut is tightened.

6. A carpet glue removal assembly for removing flooring adhesive from a concrete floor, said assembly comprising:
a plate having a curved tail piece, said plate having a top surface, a bottom surface and a perimeter edge extending between said top surface and said bottom surface, said perimeter edge having a front side, a back side, a first lateral side and a second lateral side, said plate having a pair of holes each extending through said top surface and said bottom surface, each of said holes being positioned adjacent to said front side of said perimeter edge, said holes being spaced apart from each other and being distributed along said front side, each of said first lateral side and said second lateral side curves inwardly at a point located adjacent to said back side such that said back side has a width being less that a width of said front side;
a coupler being coupled to said plate, said coupler being attachable to an oscillating tool thereby facilitating said plate to be oscillated when the oscillating tool is turned on, said coupler being positioned adjacent to said curved tail piece such that said plate is directed forwardly from the oscillating tool, said coupler having a bottom end, a top end and an outer surface extending between said top end and said bottom end, said bottom end being coupled to said top surface of said plate, said coupler being centrally positioned between said first lateral side and said second lateral side of said perimeter edge of said panel, said coupler being positioned adjacent to said curve in each of said first lateral side and said second lateral side such that said plate is directed forwardly from an output shaft of the oscillating tool when said coupler is attached to the output shaft;
a blade being removably coupled to said plate, said blade extending forwardly from said plate thereby facilitating said blade to engage adhesive on a floor such that blade removes the adhesive from the floor when said plate is oscillated, said blade having an upper surface, a lower surface and a front edge extending between said upper surface and said lower surface, said front edge having a series of intersecting faces being arranged to define a saw tooth pattern on said front edge thereby facilitating said front edge to abrade the adhesive when said plate is oscillated, said blade having a pair of apertures each extending through said upper surface and said lower surface, said apertures being spaced apart from each other and being distributed along a line being oriented parallel with said front edge, said upper surface being abutted against said bottom surface of said plate having each of said apertures being aligned with a respective one of said holes in said plate; and
a pair of fasteners, each of said fasteners being extendable through a respective hole in said panel and a respective aperture in said blade thereby attaching said blade to said panel, each of said fasteners comprising:
a screw having a head and a shaft, said shaft of each of said screws being extended through a respective hole and a respective aperture having said head abutting said top surface of said plate;
a washer being positioned around said screw such that said washer is positioned between said head and said top surface of said plate;
a nut being threadable onto said shaft of said screw, said nut compressing against said lower surface of said blade when said nut is tightened on said screw; and
a lock washer being positioned around said screw such that said lock washer is positioned between said nut and said lower surface of said blade for inhibiting said nut from loosening when said nut is tightened.

7. A carpet glue removal system for removing flooring adhesive from a concrete floor, said assembly comprising:
an oscillating tool having an output shaft, said output shaft oscillating when said oscillating tool is turned on;
a plate having a curved tail piece, said plate having a top surface, a bottom surface and a perimeter edge extending between said top surface and said bottom surface, said perimeter edge having a front side, a back side, a first lateral side and a second lateral side, said plate having a pair of holes each extending through said top surface and said bottom surface, each of said holes being positioned adjacent to said front side of said perimeter edge, said holes being spaced apart from each other and being distributed along said front side, said front side having a width being greater than a width of said back side, each of said first lateral side and said second lateral side curves inwardly at a point located adjacent to said back side such that said back side has a width being less that a width of said front side;
a coupler being coupled to said plate, said coupler being attachable to said output shaft of said oscillating tool thereby facilitating said plate to be oscillated when said oscillating tool is turned on, said coupler being positioned adjacent to said curved tail piece such that said plate is directed forwardly from said oscillating tool, said coupler having a bottom end, a top end and an outer surface extending between said top end and said bottom end, said bottom end being coupled to said top surface of said plate, said coupler being centrally positioned between said first lateral side and said second lateral side of said perimeter edge of said panel, said coupler being positioned adjacent to said curve in each of said first lateral side and said second lateral side such that said plate is directed forwardly from an output shaft of the oscillating tool when said coupler is attached to the output shaft;
a blade being removably coupled to said plate, said blade extending forwardly from said plate thereby facilitating said blade to engage adhesive on a floor such that blade removes the adhesive from the floor when said plate is oscillated, said blade having an upper surface, a lower surface and a front edge extending between said upper surface and said lower surface, said front edge having a series of intersecting faces being arranged to define a saw tooth pattern on said front edge thereby facilitating said front edge to abrade the adhesive when said plate is oscillated, said blade having a pair of apertures each extending through said upper surface and said lower surface, said apertures being spaced apart from each other and being distributed along a line being oriented parallel with said front edge, said upper surface being abutted against said bottom surface of said plate having each of said apertures being aligned with a respective one of said holes in said plate; and
a pair of fasteners, each of said fasteners being extendable through a respective hole in said panel and a respective aperture in said blade thereby attaching said blade to said panel, each of said fasteners comprising:
a screw having a head and a shaft, said shaft of each of said screws being extended through a respective hole and a respective aperture having said head abutting said top surface of said plate;
a washer being positioned around said screw such that said washer is positioned between said head and said top surface of said plate;
a nut being threadable onto said shaft of said screw, said nut compressing against said lower surface of said blade when said nut is tightened on said screw; and
a lock washer being positioned around said screw such that said lock washer is positioned between said nut and said lower surface of said blade for inhibiting said nut from loosening when said nut is tightened.
